(19) United States
(12) Patent Application Publication
(10) Pub. No.: US 2004/0054859 A1
(43) Pub. Date: Mar. 18, 2004

(54) Mouse device capable of storing data

(76) Inventors: Chanson Lin, Hsinchu (TW); Kuohong Wang, Hsinchu (TW); Tsair Jinn Cheng, Hsinchu (TW); Kuang-Yuan Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/288,500

(22) Filed: Nov. 6, 2002

(30) Foreign Application Priority Data
Sep. 13, 2002 (TW) 091214459

(51) Int. Cl. G06F 12/00

(52) U.S. Cl. 711/154

(57) ABSTRACT

A mouse device capable of storing data comprises a storage medium processor used to control and process actions between each component. The storage medium processor is connected with a device function processor, a mouse function controller, and an interface controller. The storage medium processor has a data read control circuit therein to control access of data in a storage medium. The mouse function controller is used to control and process actions of mouse. The interface controller is used to process signal handshaking and data transmission of a connection interface. A buffer memory management unit connected with a buffer memory is also provided to enhance the speed and stability of data transmission. The mouse device capable of storing device thus has both the storage function of memory peripheral and the cursor control function of mouse.

### FIELD OF THE INVENTION

The present invention relates to a mouse device and, more particularly, to a mouse device integrating the memory storage function.

### BACKGROUND OF THE INVENTION

Along with continual development of the information industry, desktop computers and notebook computers have penetrated into everyday lives of people for work or personal usage. Computer peripherals like mice and memory devices have also become inevitable products in use of computer.

When a user using a computer to perform data processing, a mouse plays an important role in the operational interface of windows. Through accurate cursor control provided by the mouse, the user can maneuver the picture on the screen at his own will to perform the actions of selection, drag, and execution, thereby performing editing of data, cutting or pasting of data, opening or closing of document, or download of document.

On the other hand, it is necessary to store various kinds of electronic data in computer products. Therefore, data storage devices like flash memories, electronic erasable programmable read-only memories (EEPROMs), or magnetic recording media also play very important roles. For example, various kinds of memory cards let users be able to freely exchange various kinds of files and documents between desktop computers or notebook computers and backup important files anytime anywhere to accomplish convenient use.

However, the cursor function of mouse and the data storage function of memory device belong to different devices. If a memory device can be built in a mouse or a memory card can be inserted into a mouse, the mouse can be used for access of data at the same time when being used as a regular mouse, hence expanding the application range of mouse. In other words, in addition to being used as a cursor device, the mouse can also be used as a data storage medium.

Accordingly, the present invention aims to propose a mouse device capable of storing data, which can be used for access of data in addition to providing the function of cursor control.

### SUMMARY OF THE INVENTION

The primary object of the present invention is to provide a mouse device capable of storing data, which can utilize an inbuilt storage medium to perform access and transmission of data at the same time when used to perform actions of windows like cursor control, click selection, and data editing, hence effectively integrating storage of memory peripheral and cursor control of mouse.

Another object of the present invention is to provide a mouse device capable of storing data, which has also a memory card slot in addition to an inbuilt storage medium, hence letting a user be able to flexibly expand the memory function according to necessity.

Yet another object of the present invention is to provide a mouse device capable of storing data, which has a universal serial bus (USB) transmission interface.

According to the present invention, a mouse device capable of storing data comprises a storage medium processor, a device function processor, a mouse function controller, and an interface controller. The storage medium processor has a data read control circuit therein to control access of data in a storage medium. The device function processor is connected with the storage medium processor, and is used to control and process actions between each component. The mouse function controller is connected with the device function processor, and is used to control and process actions of mouse. The interface controller is connected with the device function processor, and is used to process signal handshaking and data transmission of a connection interface.

The various objects and advantages of the present invention will be more readily understood from the following detailed description when read in conjunction with the appended drawing, in which:

### BRIEF DESCRIPTION OF THE DRAWINGS

FIG. 1 is a structure block diagram of a preferred embodiment of the present invention;

FIG. 2 is a flowchart of the system booting or the insertion process of the present invention;

FIG. 3 is a flowchart of the data read process of the present invention;

FIG. 4 is a flowchart of the data writing-in process of the present invention; and

FIG. 5 is a flowchart of the mouse function action process of the present invention.

### DETAILED DESCRIPTION OF THE PREFERRED EMBODIMENTS

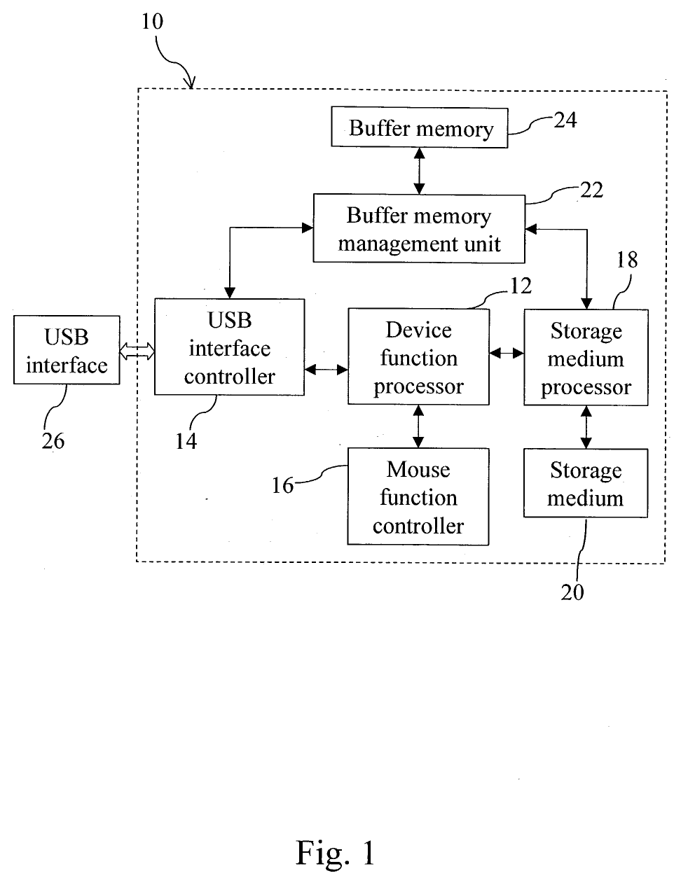

As shown in FIG. 1, a mouse device 10 capable of storing data comprises a device function processor 12 for controlling and processing actions between each component and signal communication. The device function processor 12 is electrically connected to an interface controller 14, a mouse function controller 16, and a storage medium processor 18. The interface controller 14 is usually a USB control interface, and is used to let the mouse device 10 capable of storing data connect a USB interface 26. The interface controller 14 comprises a signal transmitter and a logic control unit (not shown), and is used to process signal handshaking and data transmission of the USB interface. The mouse controller 16 is used to control and process commands about mouse actions and signal transmission. The storage medium processor 18 has a data read control circuit therein, and is used to control access of data in a storage medium 20. Besides, in order to increase stability of data read and ensure safety during data transmission process, an error correcting code (ECC) control circuit and a data encryption/decryption circuit can further be disposed in the storage medium processor 18.

The storage medium 20 is the place for access and read of data, and is usually a flash memory, an EEPROM, a magnetic recording medium, or an optical storage medium. In addition to the above storage medium 20, a memory card slot (not shown) can also be disposed in the mouse device 10 capable of storing data. The memory card slot is electrically connected to the storage medium processor 18 to be inserted by various kinds of memory cards, hence letting users be able to expand memory function according to necessity.

A buffer memory management unit 22 connected with a buffer memory 24 is also provided. The buffer memory management unit 22 is also connected to the storage medium processor 18 and the interface controller 14, and is used to manage and access the buffer memory 24, thereby enhancing the speed and stability of data transmission.

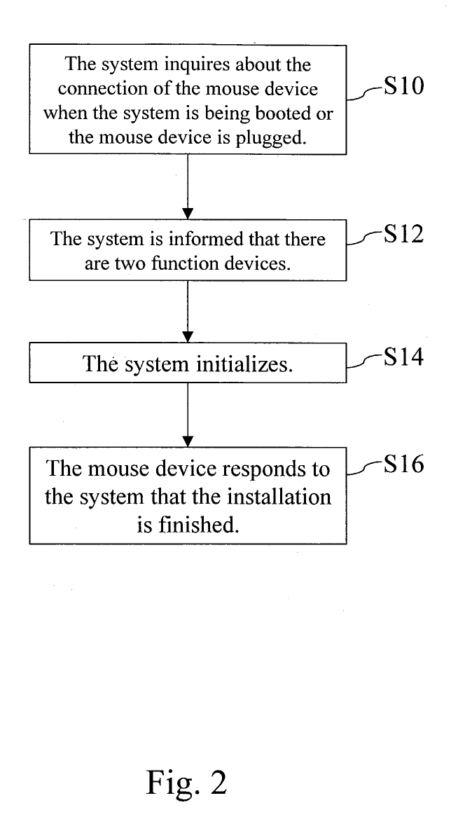

FIG. 2 is a flowchart of plugging the mouse device 10 capable of storing data for use when the system is being booted or the system is in use. First, when the system is being booted or the mouse device 10 is plugged, the system inquires about and makes sure the connection of the mouse device 10 capable of storing data (Step S10). Next, the mouse device 10 capable of storing data responds to the system that there are two function devices of mouse and memory (Step S12). The system then initializes (Step S14). Finally, the mouse device 10 capable of storing data responds to the system that the installation is finished (Step S16).

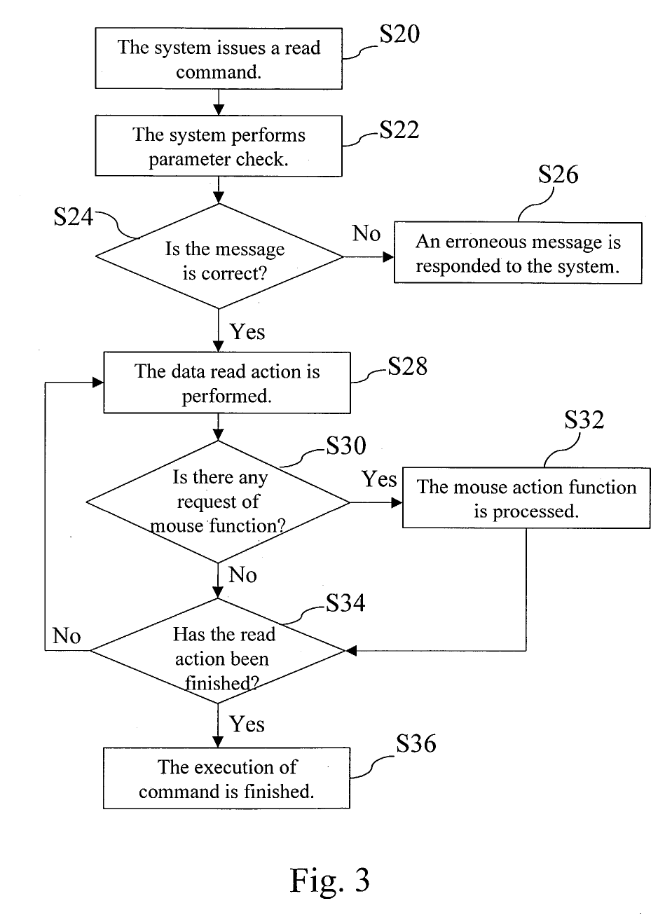

FIG. 3 is an operational flowchart of the mouse device 10 capable of storing data used for the mouse cursor and data read functions. First, the system issues a data read command (Step S20). The system then performs parameter check (Step 22). Next, the device function processor 12 determines whether message read is correct (Step 24). If message read is incorrect, the device function processor 12 responds an erroneous message to the system (Step 26); otherwise, the storage medium processor 18 performs data read actions to start reading data in the storage medium 20 (Step 28). Meanwhile, the device function processor 12 will continuously check whether there is any request of mouse function to the system (Step 30). If there is a request of mouse function, Step 32 is performed. The device function processor 12 will drive the mouse function controller 16 to preemptively process the command of mouse actions and message transmission. After the mouse function controller 16 has finished processing the command of mouse actions, the device function processor 12 will drive the storage medium processor 18 to continue performing read actions. Next, the storage medium processor 18 will respond to the device function processor 12 whether the read actions are finished (Step 34). If the read actions have not been finished yet, the Steps S28, S30, S32, and S34 are continued. Finally, during the Step S34, when the device function processor 12 makes sure that the read actions have been finished, the device function processor 12 will respond to the system that the command has been finished (Step S36).

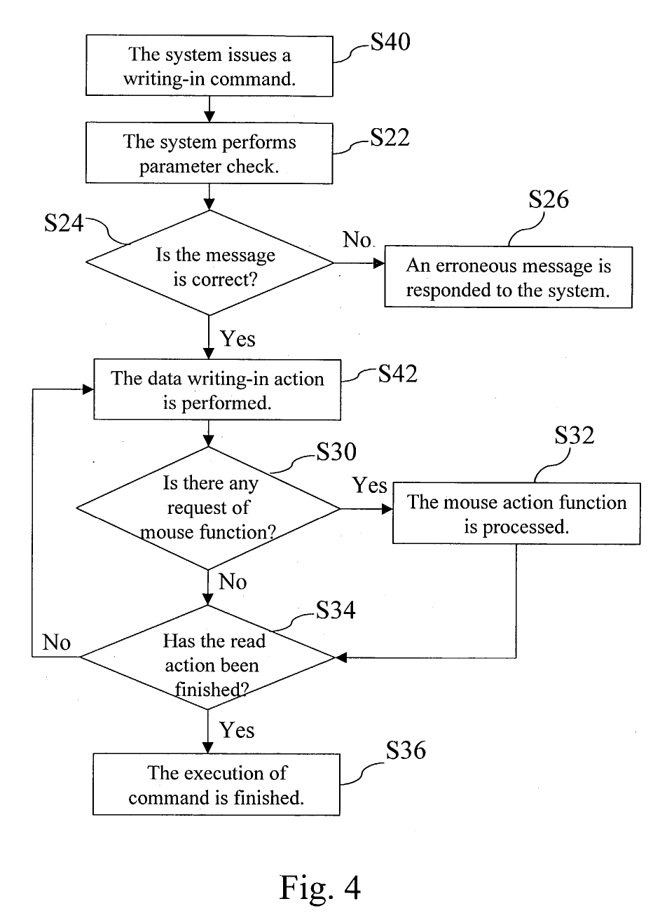

FIG. 4 is a flowchart of data writing-in actions of the mouse device 10 capable of storing data. The whole action process of data writing-in is similar to that of data read in FIG. 3. Step 20 (the system issues a read command) is replaced with Step 40 (the system issues a writing-in command), Step 28 (the storage medium processor performs data read action) is replaced with Step 42 (the storage medium processor performs data writing-in action), and Step 34 (the storage medium processor 18 responds to the device function processor 12 whether the read action is finished) is replaced with Step 44 (the storage medium processor 18 responds to the device function processor 12 whether the writing-in action is finished). The data writing-in process is the same as the data read process and thus will not be further described.

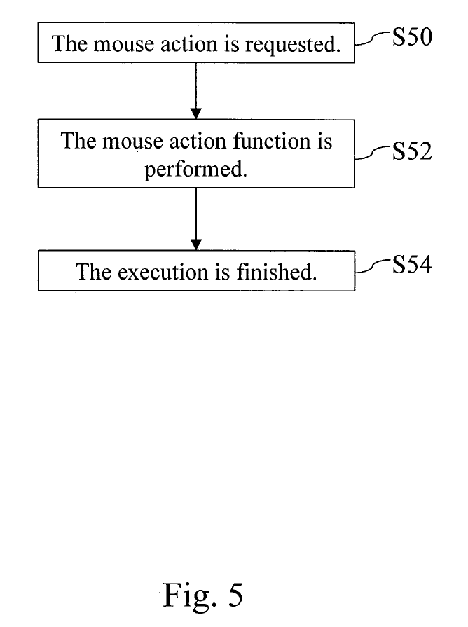

Additionally, when the system does not issue a read or writing-in command and only the simple mouse function is requested, the flowchart of the mouse device 10 capable of storing data is shown in FIG. 5. First, the system issues a request command of mouse function (Step 50). The device function processor 12 then informs the mouse function controller 16 to perform the command of mouse action (Step 52). After the mouse action has been finished, the device function processor 12 responds to the system the command has been finished (Step 54).

To sum up, the present invention makes use of a mouse device with at least an inbuilt storage medium and its processor so that the mouse device can also utilize the storage medium to perform read/write and transmission of data in addition to having the cursor function of mouse, thereby effectively integrating memory peripheral and mouse cursor control function. Moreover, a memory card slot can also be disposed for insertion of a memory card to let users be able to flexibly expand memory function according to necessity.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A mouse device capable of storing data, comprising:
at least a storage medium for storing data;
a storage medium processor having a data read control circuit therein and used to control access of data in said storage medium;
a device function processor connected with said storage medium processor and used to control and process actions between each component;
a mouse function controller connected with said device function processor and used to control and process actions of mouse; and
an interface controller connected with said device function processor and used to process signal handshaking and data transmission of a connection interface.

2. The mouse device capable of storing data as claimed in claim 1, wherein a buffer memory management unit and a buffer memory are further provided, and said buffer memory management unit is connected to said buffer memory, said storage medium processor, and said interface controller.

3. The mouse device capable of storing data as claimed in claim 1, wherein said interface controller is a universal serial bus interface controller.

4. The mouse device capable of storing data as claimed in claim 1, wherein said interface controller further comprises a signal transmitter and a logic control unit.

5. The mouse device capable of storing data as claimed in claim 1, wherein said storage medium processor further comprises an error correcting code control circuit.

6. The mouse device capable of storing data as claimed in claim 1, wherein said storage medium processor further comprises a data encryption/decryption circuit.

7. The mouse device capable of storing data as claimed in claim 1, wherein a memory card slot electrically connected to said storage medium processor is further provided.

8. The mouse device capable of storing data as claimed in claim 1, wherein said storage medium is a flash memory, an electronic erasable programmable read-only memory, a magnetic recording medium, or an optical recording medium.
